(19) United States
(12) Patent Application Publication
(10) Pub. No.: US 2006/0248166 A1
(43) Pub. Date: Nov. 2, 2006

(54) System and method for client side rendering of a web page

(76) Inventors: Jovan Milosevic, Toronto (CA); Milos Glisic, Toronto (CA); Miljan Braticevic, Toronto (CA)

Correspondence Address: BERESKIN AND PARR, 40 KING STREET WEST, BOX 401, TORONTO, ON, M5H 3Y2, CA

(21) Appl. No.: 11/117,738

(22) Filed: Apr. 29, 2005

(51) Int. Cl. G06F 15/16

(52) U.S. Cl. 709/219

(57) ABSTRACT

The present invention relates generally to a system and method for delivering a requested web page from a server to a client. The server does not render the requested web page to provide the complete markup of the web page to be displayed on the client. Instead, the server generates a response comprising arrays of data and a programming script. A browser on the client utilizes the programming script to parse the arrays and generate markup code to display the requested web page on the client.

### FIELD OF THE INVENTION

The present invention relates to a system and method for utilizing a server to generate information for a web browser on a client, the information being used by the web browser to display a web page.

### BACKGROUND OF THE INVENTION

In utilizing the World Wide Web (WWW) to view a web page it is common practice to have a web server generate the required Hypertext Markup code (HTML) and the necessary programming to allow a user to view a web page. Typically this is achieved by a user on a client device requesting a specific web page from a server, through the use of a browser such as Internet Explorer, Netscape or Firefox. Upon receiving the request for a specific web page the server utilizes code on the server to generate HTML and the associated code (for example JavaScript) to allow the browser to display the web page on the client device.

Such implementations require that the server generate all of the HTML and associated code to allow a browser to display the web page. These implementations transmit significant amounts of data to the client device, and force the browser to create DOM (Document Object Model) objects for every markup element generated by the server. As these DOM trees get larger browser performance deteriorates.

Thus there is a need to reduce the amount of data to be sent to the client device, as well as improve browser performance when large pages are handled. The present invention addresses this need.

### SUMMARY OF THE INVENTION

The present invention is directed to a method for displaying on a client, a web page provided by a server, said method comprising the steps of:

receiving on said server a request for said web page;

reading a data resource;

generating a response based upon the contents of said web page and said data resource, said response comprising a data portion and a script portion;

sending said response to said client; and

utilizing a browser and said data portion to generate markup on said client to display said web page on said client.

The present invention is also directed to a system for displaying on a client, a web page provided by a server, said method comprising the steps of:

means for receiving on said server a request for said web page;

means for reading a data resource;

means for generating a response based upon the contents of said web page and said data resource, said response comprising a data portion and a script portion;

means for sending said response to said client; and

means for utilizing a browser and data portion to generate markup on said client to display said web page on said client.

The present invention is further directed to a computer readable medium comprising instructions for displaying on a client, a web page provided by a server, said medium comprising:

instructions for receiving on said server a request for said web page;

instructions for reading a data resource;

instructions for generating a response based upon the contents of said web page and said data resource, said response comprising a data portion and a script portion;

instructions for sending said response to said client; and

instructions for utilizing a browser and said data portion to generate markup on said client to display said web page on said client.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram illustrating communication between a server and a client device; and

FIG. 2 is a flowchart of the process of client side rendering of a web page.

### DETAILED DESCRIPTION OF THE INVENTION

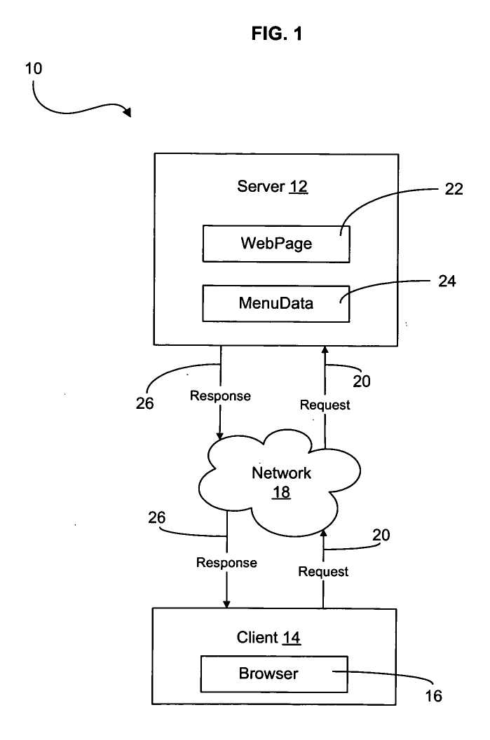

To aid the reader in understanding how the present invention may be used we refer first to FIG. 1 a block diagram illustrating communication between a server and a client device, shown generally as system 10. System 10 is well recognized in the industry to be a standard configuration and as described below is to be considered prior art.

System 10 comprises a server 12 and a client 14, the client 14 containing a browser 16. By way of example, server 12 may be a Microsoft Internet Information Server utilizing ASP.NET. Browser 16 may be a web browser such as Internet Explorer or Firefox.

Server 12 and client 14 communicate via a network 18 such as the Internet. In use browser 16 residing on client 14 issues a request 20 via network 18 for a particular web page on server 12, for example WebPage 22. WebPage 22 resides within server 12 along with a data resource such as MenuData 24 necessary to display WebPage 22. Examples of embodiments for MenuData 24 as a data resource may include a data resource implemented as a program that extracts data to aid in the display of a WebPage 22, the data may reside on server 12 in any number of forms, for example XML data, XML streams or SQL databases.

Upon receiving request 20, server 12 utilizes WebPage 22 and MenuData 24 to generate a Hypertext Markup code (HTML) file along with the code necessary to display WebPage 22. The code is in a format such as JavaScript, which is natively supported by browser 16. The HTML file and code are sent to browser 16 in response 26 via network 18.

Upon receiving response 26, browser 16 executes the code provided by server 12 to display the requested web page. In typical use the code provided would implement a user interface, such as display and hiding menu groups or expanding treeview nodes. In keeping with our example of a standard system 10, WebPage 22 would conform to the ASP.NET syntax provided by Microsoft. A simple implementation of WebPage 22 follows as Example 1.

### Example 1

```
<%@ Page Language=“C#” %>
<%@ Register TagPrefix=“Generic” Namespace=“GenericMenuControl”
    Assembly=“GenericMenuControl” %>
<html>
  <body>
  <Generic:Menu id=“Menu1” XmlDataFile=“MenuData.xml”
  runat=“server”/>
  </body>
</html>
```

In the above example, WebPage 22 contains definitions for a complete user interface, which will be generated by server 12 and sent to browser 16. These definitions comprise two types of tags, namely:

1. Flat HTML markup tags such as <html>, <body> and <table>, which are sent to browser 16 without change.

2. Server control tags (containing the runat=“server” attribute) which are executed on server 12 and transformed to code compatible with browser 16, for example a combination of HTML markup tags and JavaScript.

A simple example of MenuData 24 is shown as an XML file in the following Example 2.

### Example 2

### MenuData 24

```
<MenuData>
  <MenuItem Text=“Products” NavigateUrl=“products.aspx”>
    <MenuItem Text=“Product A” NavigateUrl=“productA.aspx” />
    <MenuItem Text=“Product B” NavigateUrl=“productB.aspx” />
    <MenuItem Text=“Product C” NavigateUrl=“productC.aspx” />
  </MenuItem>
  <MenuItem Text=“Services” NavigateUrl=“services.aspx”>
    <MenuItem Text=“Custom Development” NavigateUrl=“develop.aspx”
/>
    <MenuItem Text=“Consulting” NavigateUrl=“consulting.aspx” />
    <MenuItem Text=“Training” NavigateUrl=“training.aspx” />
  </MenuItem>
  <MenuItem Text=“About” NavigateUrl=“about.aspx”>
    <MenuItem Text=“Corporate” NavigateUrl=“corporate.aspx” />
    <MenuItem Text=“What's New” NavigateUrl=“whatsNew.aspx” />
    <MenuItem Text=“Contact Us” NavigateUrl=“contactUs.aspx” />
  </MenuItem>
</MenuData>
```

In the above Example 2, MenuData 24 is an XML file containing a definition of a menu structure. Example 2 comprises a series of nested MenuItem elements, all contained within a single MenuData element. Each menu item contains Text and NavigateUrl attributes which are used to define the text which will be displayed within a menu item, and the Uniform Resource Locator (URL) that browser 16 will be directed to after a user clicks on that item.

The output of WebPage 22 is generated as HTML content, which is delivered to browser 16 on client 14 via response 26. An example of a response 26 based upon Examples 1 and Example 2 is shown below as Example 3.

### Example 3

### Response 26

```
<html>
  <body>
  <table cellpadding=“0” cellspacing=“0>
    <tr><td><a href=“products.aspx”>Products</a></td></tr>
    <tr><td><a href=“services.aspx”>Services</a></td></tr>
    <tr><td><a href=“about.aspx”>About</a></td></tr>
  </table>
  <table style=“visibility:hidden;” cellpadding=“0” cellspacing=“0”>
    <tr><td><a hxef=“productA.aspx”>Product A</a></td></tr>
    <tr><td><a href=“productB.aspx”>Product B</a></td></tr>
    <tr><td><a href=“productC.aspx”>Product C</a></td></tr>
  </table>
  <table style=“visibility:hidden;” cellpadding=“0” cellspacing=“0”>
    <tr><td><a href=“develop.aspx”>Custom Development</a></td></tr>
    <tr><td><a href=“consulting.aspx”>Consulting</a></td></tr>
    <tr><td><a href=“training.aspx”>Training</a></td></tr>
    </table>
  <table style=“visibility:hidden;” cellpadding=“0” cellspacing=“0”>
    <tr><td><a href=“corporate.aspx”>Corporate</a></td></tr>
    <tr><td><a hxef=“whatsNew.aspx”>What's New</a></td></tr>
    <tr><td><a href=“contactUs.aspx”>Contact Us</a></td></tr>
  </table>
  <script language=“javascript”>
  // JavaScript code used to implement user interaction behaviour
  // such as displaying and hiding menu groups
  </script>
  </body>
</html>
```

In the above Example 3, as browser 16 supports both HTML and JavaScript, browser 16 is able to:

1. Display a user interface defined by the HTML of Example 3; and

2. Execute the JavaScript code of Example 3 allowing for the implementation of user interaction logic, such as displaying and hiding menu groups when a user moves a mouse over a menu item.

Referring now to the present invention with reference to FIG. 1, we describe an improvement on the prior art illustrated in Examples 1 to 3. The present invention does not generate any HTML code on server 12. Rather, data required to generate the web user interface is provided in the form of nested JavaScript arrays. The generation of HTML is then done by browser 16, through the use of JavaScript.

### Example 4

### WebPage 22

```
<%@ Page Language=“C#” %>
<%@ Register TagPrefix=“ComponentArt”
Namespace=“ComponentArt.Web.UI”
    Assembly=“ComponentArt.Web.UI” %>
<html>
  <body>
  <ComponentArt:Menu id=“Menu1” SiteMapXmlFile=“menuData.xml”
    runat=“server” />
  </body>
</html>
```

Example 4 is essentially the same as Example 1 save that it contains an instance of a ComponentArt menu control.

Example 5 as follows is identical to Example 2 of the prior art.

### MenuData 24

### Example 5

```
<MenuData>
  <MenuItem Text=“Products” NavigateUrl=“products.aspx”>
    <MenuItem Text=“Product A” NavigateUrl=“productA.aspx” />
    <MenuItem Text=“Product B” NavigateUrl=“productB.aspx” />
    <MenuItem Text=“Product C” NavigateUrl=“productC.aspx” />
  </MenuItem>
  <MenuItem Text=“Services” NavigateUrl=“services.aspx”>
    <MenuItem Text=“Custom Development” NavigateUrl=“develop.aspx”
/>
    <MenuItem Text=“Consulting” NavigateUrl=“consulting.aspx” />
    <MenuItem Text=“Training” NavigateUrl=“training.aspx” />
  </MenuItem>
  <MenuItem Text=“About” NavigateUrl=“about.aspx”>
    <MenuItem Text=“Corporate” NavigateUrl=“corporate.aspx” />
    <MenuItem Text=“What's New” NavigateUrl=“whatsNew.aspx” />
    <MenuItem Text=“Contact Us” NavigateUrl=“contactUs.aspx” />
  </MenuItem>
</MenuData>
```

As can be seen from the following Example 6, a response 26 is quite different from the prior art of Example 3.

### Example 6

### Response 26

```
<html>
  <body>
  <script language=“javascript”>
  //<![CDATA[
  var ComponentArt_Storage_Menu1 =
  [[‘pb_0’,−1,[1,2,3],‘Products’,‘products.aspx’,],
  [‘pb_1’,−1,[ ],‘Product A’,‘productA.aspx’,],
  [‘pb_2’,−1,[ ],‘Product B’,‘productB.aspx’,],
  [‘pb_3’,−1,[ ],‘Product C’,‘productC.aspx’,],
  [‘pb_4’,−1,[5,6,7],‘Services’,‘services.aspx’,],
  [‘pb_5’,−1,[ ],‘Custom Development’,‘develop.aspx’,],
  [‘pb_6’,−1,[ ],‘Consulting’,‘consulting.aspx’,],
  [‘pb_7’,−1,[ ],‘Training’,‘training.aspx’,],
  [‘pb_8’,−1,[9,10,11],‘About’,‘about.aspx’,],
  [‘pb_9’,−1,[ ],‘Corporate’,‘corporate.aspx’,],
  [‘pb_10’,−1,[ ],‘What\'s New’,‘whatsNew.aspx’,],
  [‘pb_11’,−1,[ ],‘Contact Us’,‘contactUs.aspx’,],]
  //]]>
  </script>
  <script language=“javascript”>
  // JavaScript code used to:
  // 1. Generate the HTML markup code required to define the
  //  user interface;
  // 2. Implement user interaction behaviour such as displaying
  //  and hiding menu groups
  </script>
  </body>
</html>
```

The responses 26 as shown in Examples 3 and 6 differ considerably. Rather than generating complete HTML code as shown in Example 3, only the data is generated in Example 6, in the form of JavaScript arrays. The generation of the required HTML is then performed on the client side by browser 16, through the use of JavaScript code, which resides within response 26. The response of Example 6 comprises two separate components, a data portion and a script portion. Thus, the provision of a data portion and a script portion allow a client side browser to utilize the data and code to generate the required markup code and display the requested web page on client 14.

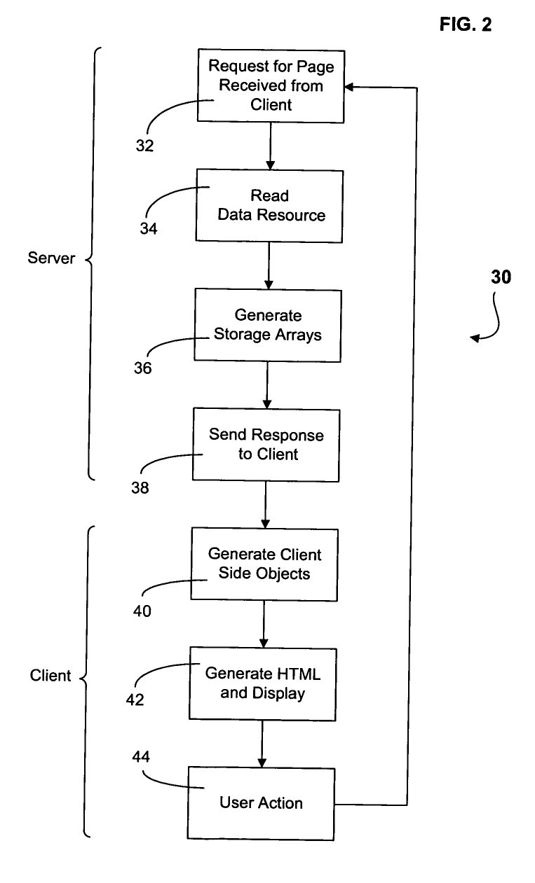

Referring now to FIG. 2, a flowchart of the process of client side rendering of a web page is shown generally as 30. Beginning at step 32 a request 20 to display a WebPage 22 is received from browser 16 on client 14 by server 12. At step 34 WebPage 22 utilizes a data resource such as MenuData file 24 to aid in the construction of a response 26. At step 36 a response 26 containing data and script is generated. The format of an example response 26 is shown in Example 6 above. At step 38 the response 26 is forwarded to client 14 for display. At step 40, browser 16 on client 14 utilizes the data and script of response 26 to generate client side objects, which reside within the memory of browser 16. At step 42 utilizing the client side objects generated at step 42 the necessary HTML markup is generated and the web page requested at step 32 is displayed by browser 16. At step 44 a user may make a selection from the web page generated at step 42 and processing returns to step 32 where a new web page is generated. The process between steps 44 and 32 repeats until the user selects a web page that is not provided by server 12 or the user disconnects from network 18.

We now provide more detail on the steps of FIG. 2. Having received a request for a WebPage 22 (Example 4) at step 32, server 12 then reads MenuData 24 (Example 5) at step 34 to generate a response 26 at step 36.

To aid the reader in understanding references to various terms in the description as follows, we provide the following definitions for values, objects and properties:

Values are single entries within JavaScript storage arrays. For example: [‘pb_{—}0’,−1,[1,2,3],‘Products’,‘products.aspx’]. Objects are entities that encapsulate multiple properties. MenuItem in Example 7 below is an object that encapsulates properties for Text, and NavigateUrl. There is a one-to-one mapping between values from storage arrays and object properties. In other words, an object on the client is populated from the values in a storage array.

In order to generate the data portion of a response 26, it is necessary to decide which properties, and in which order, will get stored in the data portion. In the case of hierarchical structures, there is also a requirement to represent parent-child relationships. This is achieved by generating nested arrays (a parent storage array contains storage arrays of its children) or, as in Example 6, by outputting indices of child storage arrays within the main storage array.

An example for doing the latter would involve first determining the objects which need to be output into the data portion of a response 26 to create a temporary structure of arrays of values. This recursive algorithm may be implemented as follows:

### Example 7

### Server Side Generation of Data Arrays

```
ArrayList BuildStorage(MenuItemCollection arItems)
{
  ArrayList arItemList = new ArrayList( );
  foreach(MenuItem oItem in arItems)
  {
    ProcessItem(oItem, arItemList, −1, 1);
  }
}
int ProcessItem(MenuItem oItem, ArrayList arItemList)
{
  // Create an array to store the data for this MenuItem
  ArrayList arItemElements = new ArrayList( );
  // This will be this item's index within the storage array.
  // Remember it so we can return it in the end.
  int iIndex = arItemList.Count;
  // Add this item's array to the main storage array.
  arItemList.Add(arItemElements);
  // Add the ID
  arItemElements.Add(oItem.ID);
  // Create an array to store child indices within the resulting array
  ArrayList arChildIndices = new ArrayList( );
  // Process child items, and add their indices
  // to this item's child index array
  foreach(MenuItem oChildItem in oItem.ChildItems)
  {
    // Add this child's index to this item's child index array.
    arChildIndices.Add(ProcessItem(oChildItem, arItemList));
  }
  // Add the child indices
  arItemElements.Add(arChildIndices);
  // Add the Text
  arItemElements.Add(oItem.Text);
  // Add the URL
  arItemElements.Add(oItem.URL);
  // Return this item's index
  return iIndex;
}
```

In the case of hierarchical storage representations (nested storage arrays instead of child-index arrays) with string-indexed properties (i.e. properties that are collections of other properties), another method may be employed. In such a case there is no need to keep track of child indices and the named properties can be added in a loop.

After the temporary structure of array values has been generated all that remains is to execute a program which will convert the temporary structure to a string in the form of an array to be stored in the data portion of response 26. The pseudo-code for such a program follows as Example 8.

### Example 8

### Converting Data for a Response

```
string arrayToClientStorage(array itemArray)
{
  stringArray = new string array;
  for each(item in itemArray)
    if item is array then
      stringArray.add(arrayToClientStorage(item))
    else
      stringArray.add(client-side representation of item)
    end if
  end for
  return ”[” + stringArray.Join(”,”) + ”]”
}
```

Referring back to FIG. 2, once a response 26 has been generated at step 36 and sent to client 14 at step 38, processing moves to step 40. At step 40, browser 16 generates client side objects to render the requested web page on client 14.

The data portion of response 26, when combined with property names, permits the creation of objects on client 14 with named properties and values loaded from the data portion. For instance, for the above Example 6, a property array for a single client object instance may be defined as:

var properties=[‘ID’,‘ChildIndices’,‘Text’,‘URL’];

The script portion of a response 26 may then be used by browser 16 to run through the data arrays of response 16 and instantiate objects containing the data stored therein as shown in Example 9. The code shown in Example 9 resides within the script portion of response 26.

### Example 9

### Generating Client Objects

```
for each itemArray in ComponentArt_Storage_Menu1
  // create a new object to correspond to this array in the storage
  var newObject = new ComponentArt_MenuItem( )
  for property = 0 to properties.length
    // set properties of the given names on the object
    // to values loaded from storage
    newObject[properties[property]] = itemArray[property]
  end for
  add newObject to objectList
end for
```

After client objects are created from the data portion of response 26, client side rendering can be performed using the script portion of response 26.

The use of compact client side storage, when combined with property names, allows the creation of objects on the client with named properties and values loaded from storage. For instance, for the above storage example, a property array may be defined as:

var properties=[‘ID’,‘ChildIndices’,‘Text’,‘URL’];

Client side logic can then be used to run through the storage and instantiate objects containing the data stored therein.

The client objects created define methods to produce markup code, such as HTML, based on the data in the object as shown in step 42 of FIG. 2. The inventors suggest two ways of producing markup code. The first is shown in Example 10 through the use of predefined markup generation. The second is shown in Example 11 through the use of markup client templates, which allow a developer to create custom markup.

Referring now to Example 10 an example of predefined markup generation is shown. The code shown in Example 10 resides in the script portion of response 26. The data object ComponentArt_MenuItem may contain a method as shown in Example 10.

### Example 10

### Client Object—Predefined Markup

```
ComponentArt_MenuItem.prototype.GetHtml = function( );
{
  var htmlArray = new Array( );
  htmlArray[htmlArray.length] = ”<div id=\”” + this.ID + ”\”>”;
  htmlArray[htmlArray.length] = ”<a href=\”” + this.URL + ”\”>”;
  htmlArray[htmlArray.length] = this.Text + ”</a>”;
  htmlArray[htmlArray.length] = ”</div>”;
  return htmlArray.join(”);
}
```

In order to provide a developer with the ability to generate custom markup from the objects created on the client, markup client templates may be provided. A markup client template is a string containing markup (in this example HTML) and custom tags with client side script expressions, which are evaluated, and the result put in their place in the string. For example, a markup client template for a MenuItem may look as follows:

’<div id=”## DataItem.ID ##”>Link generated on ## (new Date( ))
##:<br><a href=”## DataItem.NavigateURL ##”>## DataItem.Text
##</a></div>’

Expressions between pairs of hashes are evaluated as client side script, with the DataItem identifier being pre-defined as the item the template is being instantiated for. In this example, it is a MenuItem, though it could be any other client side object specified for the particular application. The above example adds a time stamp of the template's instantiation to demonstrate the ability to include any client script logic in markup client templates.

Referring now to Example 11 an example of the logic describing the instantiation of a markup client template, or its binding to a client object of markup client templates to generate markup is shown.

### Example 11

### Client Object—Template

```
function InstantiateClientTemplate(sTemplate, DataItem)
{
  var arChunks = sTemplate.split(“##”);
  for(var i = 1; i < arChunks.length; i += 2)
  {
  arChunks[i] = eval(arChunks[i]);
  }
return arChunks.join(‘’);
}
```

In the case of both Examples 10 and Example 11, the generated markup (in this case HTML) can then be displayed by setting the innerHTML property of a designated Document Object Model (DOM) object, which is to contain the content.

The present invention provides two benefits over the prior art in permitting generation of HTML code by browser 16 on client 14 rather than on server 12. The benefits are:

a) less data required in a response 26; and

b) client side rendering performance.

Regarding the need for less data, the present invention delivers only the essential data required to generate a web page or a web page fragment. For the purposes of this disclosure and claims, whenever the term “web page” is referenced, it is meant to encompass not only a complete web page but also a web page fragment.

In the case of complex web pages, the inventors have found that when compared to the prior art, the use of client side rendering reduces the size of a response by up to 90%. As the speed of the network 18 may vary considerably, particularly in the case of low speed dialup connections, this provides significant savings in the amount of data sent and thus the time to send it.

With regard to rendering speed, in the prior art, all HTML elements are provided in response 26. Browser 16 has to parse all of these elements and create the corresponding Document Object Model (DOM) tree structure. This includes both elements displayed on the screen, as well as hidden elements (such as invisible menu groups or treeview nodes).

As the DOM tree grows bigger, the overall responsiveness of the browser deteriorates, causing slower reactions to user actions. With the present invention, only the elements visible on the screen exist within the DOM tree. This results in improved browser performance when handling complex user interfaces (with a large number of menu items, treeview nodes, and grid rows).

In the examples illustrating how to implement the present invention reference is made to HTML, XML and ASP.NET. It is not the intent of the inventors to restrict the present invention to the use of such technologies. For example, client devices may utilize xHTML and derivatives. In the case of devices that do not support HTML or xHTML, WML may be utilized. Also, any other markup codes may be used, such as XAML. Similarly alternatives to ASP.NET may be utilized on a server 12 to generate a response 26 to a request 20 for a WebPage. Such alternatives may include J2EE, JavaServer Faces, PHP or ASP. Further, although JavaScript and C# have been referred to, any language such as Java, C, C++, VisualBasic, or VBScript may used by server 12 and browser 16.

It is not the intent of the inventors to restrict browser 16 to residing on any specific form of client 14. Any client 14 capable of supporting a web browser 16 may utilize the present invention. Example of clients 14 may include personal digital assistants, cell phones, BlackBerries, set top boxes connected to a television, and other client devices. Examples of browsers may include Internet Explorer, Firefox, and Netscape.

Although we have explained the invention using a menu control as an example, it is not the intent of the inventors to limit the invention to menu user interface, rather—the invention can be used to generate any type of user interface, such as: grids, treeviews, tabstrips, navbars, listboxes, or other user interface elements.

Although we have used an XML file to describe how data may be defined, it is not the intent of the inventors to limit the invention to implementations based on XML representations of data. Other possible implementations include: data residing in SQL databases, data being generated programmatically through server-side code, data retrieved from other servers through XML streams or the SOAP protocol.

With regard to network 18, any type of network utilizing a communications protocol capable of transmitting a request 20 and a response 26 between a server 12 and a client 14 is intended by the inventors to be within the scope of the present invention. It is not the intent of the inventors to restrict network 18 to the use of the Internet. For example a wireless network or LAN having a protocol other than TCP/IP or UDP may also be utilized.

Although the present invention has been described as being a software based invention, it is the intent of the inventors to include computer readable forms of the invention. Computer readable forms meaning any stored format that may be read by a computing device.

Although the invention has been described with reference to certain specific embodiments, various modifications thereof will be apparent to those skilled in the art without departing from the spirit and scope of the invention as outlined in the claims appended hereto.

We claim:

1. A method of displaying on a client, a web page provided by a server, said method comprising the steps of:
receiving on said server a request for said web page;
reading a data resource;
generating a response based upon the contents of said web page and said data resource, said response comprising a data portion and a script portion;
sending said response to said client; and
utilizing a browser and said data portion to generate markup on said client to display said web page on said client.

2. The method of claim 1 wherein said generating a response further comprises the step of generating said data portion in the form of arrays of data.

3. The method of claim 1 further comprising the step of creating client side objects utilizing said data portion and said script portion, said client side objects being utilized to generate said markup.

4. The method of claim 1 wherein said markup is generated on said client utilizing predefined markup.

5. The method of claim 1 wherein said markup is generated on said client by utilizing markup client templates.

6. A system for displaying on a client, a web page provided by a server, said method comprising the steps of:
means for receiving on said server a request for said web page;
means for reading a data resource;
means for generating a response based upon the contents of said web page and said data resource, said response comprising a data portion and a script portion;
means for sending said response to said client; and
means for utilizing a browser and data portion to generate markup on said client to display said web page on said client.

7. The system of claim 6 wherein said means for generating a response further comprises means for generating said data portion in the form of arrays of data.

8. The system of claim 6 further comprising means for creating client side objects utilizing said data portion and said script portion, said client side objects being utilized to generate said markup.

9. The system of claim 6 wherein said markup is generated on said client utilizing predefined markup.

10. The system of claim 6 wherein said markup is generated on said client by utilizing markup client templates.

11. A computer readable medium comprising instructions for displaying on a client, a web page provided by a server, said medium comprising:
instructions for receiving on said server a request for said web page;
instructions for reading a data resource;
instructions for generating a response based upon the contents of said web page and said data resource, said response comprising a data portion and a script portion;
instructions for sending said response to said client; and
instructions for utilizing a browser and said data portion to generate markup on said client to display said web page on said client.

12. The medium of claim 11 wherein said instructions for generating a response further comprises instructions for generating said data portion in the form of arrays of data.

13. The medium of claim 11 further comprising instructions for creating client side objects utilizing said data portion and said script portion, said client side objects being utilized to generate said markup.

14. The medium of claim 11 further comprising instructions to generate said markup on said client by utilizing predefined markup.

15. The medium of claim 11 further comprising instructions to generate said markup on said client by utilizing markup client templates.
